(19) United States
(12) Patent Application Publication
(10) Pub. No.: US 2015/0359370 A1
(43) Pub. Date: Dec. 17, 2015

(54) ADJUSTABLE MAILBOX

(71) Applicant: Kenneth John Malone, Burlington, CT (US)

(72) Inventor: Kenneth John Malone, Burlington, CT (US)

(21) Appl. No.: 14/306,936

(22) Filed: Jun. 17, 2014

(51) Int. Cl. A47G 29/122; F16M 11/28

(52) U.S. Cl. CPC A47G 29/1216; F16M 11/28

(57) ABSTRACT

An adjustable mailbox is provided. The adjustable mailbox may include post having an inner post and an outer post. The inner post may fit within and telescope relative to the outer post. The outer post may include a pin hole, and the inner post may include a plurality of adjustment holes. A pin may fit within the pin hole and an aligned adjustment hole. To adjust the height of the mailbox, the pin may be removed, the inner post may be adjusted so that a different adjustment hole is aligned with the pin hole, and the pin may be inserted into the pin hole and the different adjustment hole to fix the post in place.

### BACKGROUND OF THE INVENTION

The present invention relates to mailboxes and, more particularly, to an adjustable mailbox.

A mailbox is a receptacle for receiving incoming mail at a private residence or business. Currently, in rural areas, mailboxes are placed on a post near the street or curbside. During excessive snow falls, a snow plower may not see a curbside mailbox because the mailbox may be buried in snow. The snow plower may therefore destroy the mailbox during the process of plowing snow. Further, the mailbox is currently at a height in which vandals may easily extend from theft cars and destroy the mailbox using a bat or a crow bar.

As can be seen, there is a need for a mailbox post that may adjust in height.

### SUMMARY OF THE INVENTION

In one aspect of the present invention, an adjustable mailbox comprising: a post comprising a bottom end and a top end, wherein the post is adjustable in height, the post comprising a substantially hollow outer post and an inner post that fits within the outer post, wherein the inner post comprises a fixed position relative to the outer post, and an adjustable position in which the inner post telescopes relative to the outer post; and a mailbox attached to the top end of the post.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is an exploded view of the present invention;

FIG. 3 is a side view of the present invention, shown in use;

FIG. 4 is a section view of the present invention, taken along line 4-4 in FIG. 3;

FIG. 5 is a section view of the present invention, taken along line 5-5 in FIG. 4;

FIG. 6 is a section view of the present invention, taken along line 6-6 in FIG. 5;

FIG. 7 is a section view of the present invention, taken along line 7-7 in FIG. 3;

FIG. 8 is a section view of the present invention, taken along line 8-8 in FIG. 7;

FIG. 9 is a perspective view of an alternate embodiment of the present invention, shown in use;

FIG. 10 is a perspective view of an alternate embodiment of the present invention; and

FIG. 11 is an exploded view of an alternate embodiment of the present invention.

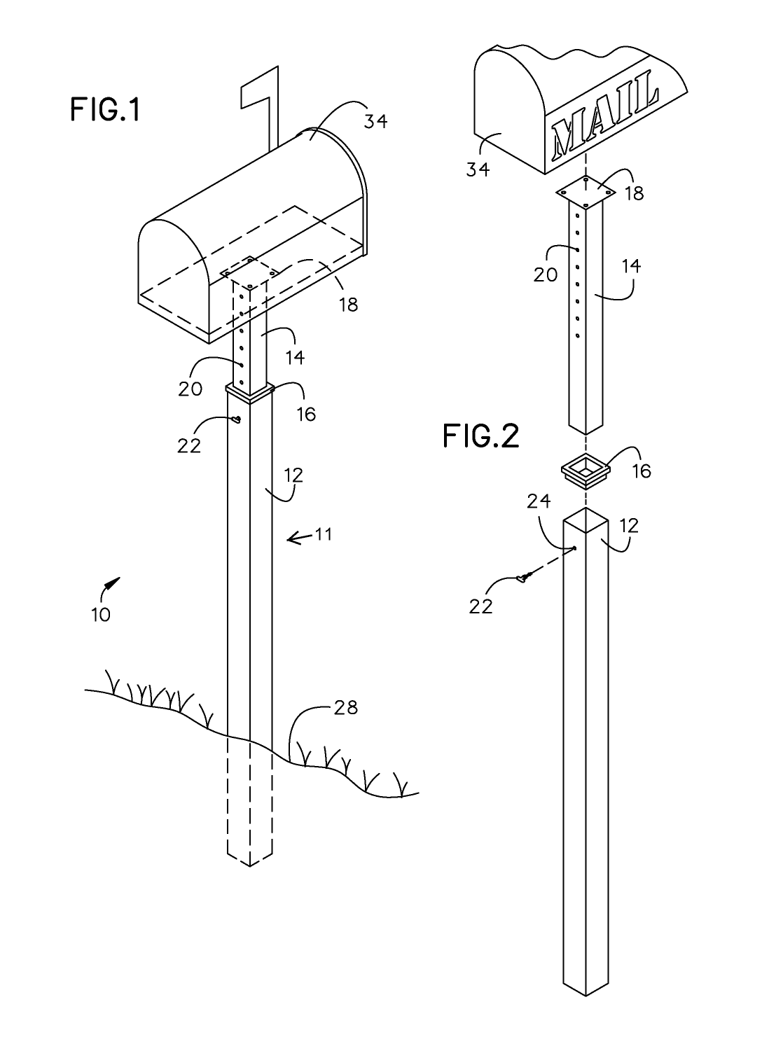

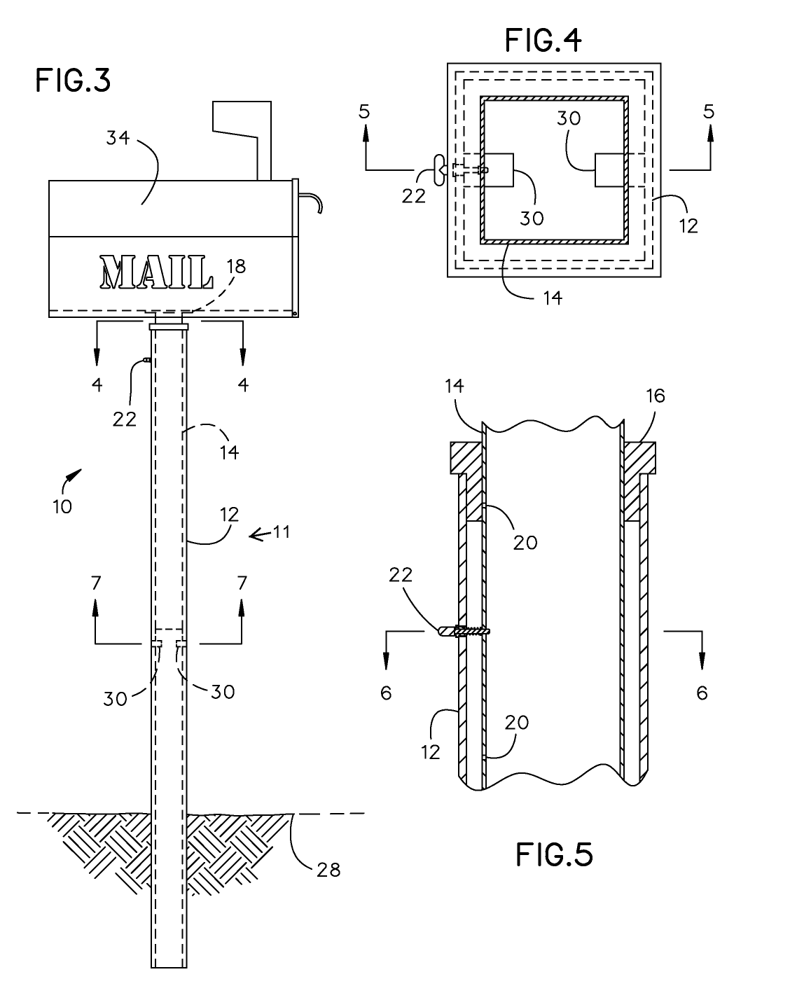

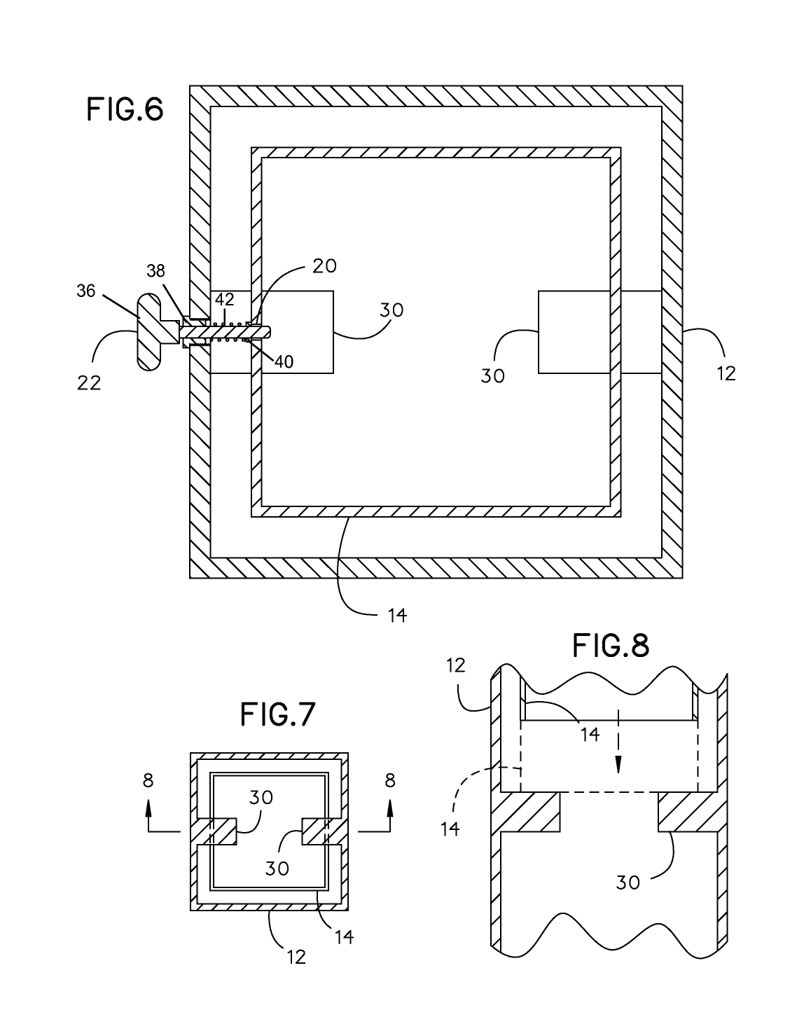

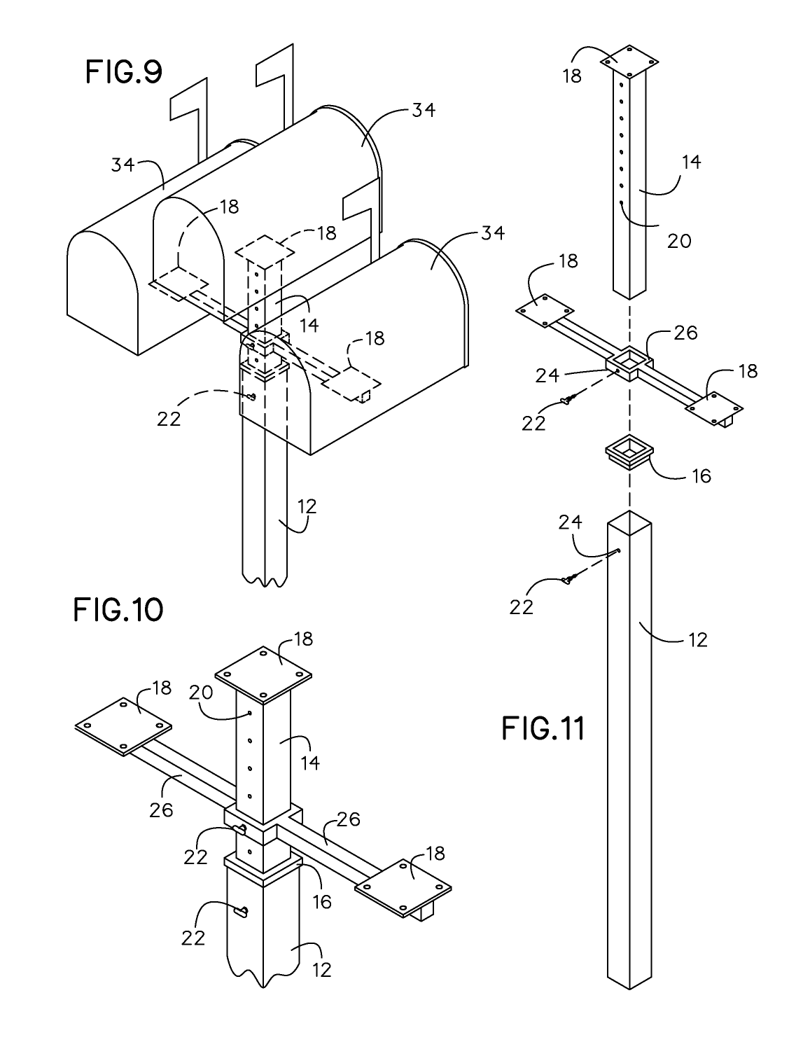

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an adjustable mailbox. The adjustable mailbox may include an inner post and an outer post. The inner post may fit within and telescope relative to the outer post. The outer post may include a pin hole, and the inner post may include a plurality of adjustment holes. A pin may fit within the pin hole and an aligning adjustment hole. To adjust the height of the mailbox, the pin may be removed, the inner post may be adjusted so that a different adjustment hole is aligned with the pin hole, and the pin may be inserted.

The present invention includes an adjustable mailbox post that may hold three mailboxes and prevent damage to the mailbox due to winter plowing, snow banks, floods, vandalism and the like. The adjustable mailbox post allows the consumer to meet the guidelines of the postal service by adjusting the height from 41 to 45 inches and also to exceed 45 inches so that the user may set the height prior to plowing preventing damage.

The present invention includes an adjustable mailbox 10 including a post 11. The post 11 may include a top end and a bottom end. The bottom end may be mounted to the ground 28 and the top end may secure a mailbox 34. In certain embodiments, the post 11 may be adjustable in height. The post 11 may include a substantially hollow outer post 12 and an inner post 14 that fits within the outer post 12. The inner post 14 may include a fixed position relative to the outer post 12. The post 11 may be adjusted in height in an adjustable position in which the inner post 14 telescopes relative to the outer post 12.

In certain embodiments, the outer post 12 may be secured to the ground 28 and may include the bottom end, while the inner post 14 may secure the mailbox 34 and include the top end. The outer post 12 may include a stop flange 30 within the substantially hollow core, preventing the inner post 12 from moving further downward into the inner post 14. A stabilizer insert 16 may be placed on the top end of the outer post 12 and may include an opening sized to fit the inner post 12, and thereby preventing the inner post 14 from moving laterally. In certain embodiments, the top end of the inner post 14 may include a substantially flat mailbox plate 18. The mailbox plate 18 may be substantially perpendicular relative to the inner post 14. The mailbox 34 of the present invention may be attached to the mailbox plate 18.

The inner post 14 and the outer post 12 may be placed in a fixed position and may telescope to adjust the height of the post 11. The inner post 14 and the outer post 12 may adjust relative to one another by utilizing an assortment of holes and pins, clamps, cam locks and the like. For example, the inner post 12 may include a plurality of adjustment holes 20 running along the height. The outer post 12 may include at least one pin hole 24 positioned to align with the adjustment holes 20. A pin 22 may fit through the pin hole 24 and at least one of the adjustment holes 20 to retain the inner post 14 in a fixed position relative to the outer post 12. To telescope the inner post 14 and outer post 12 and thereby adjust the height of the post 11, the pin 22 may be removed, the inner post 14 may be adjusted, the at least one pin hole 24 may be aligned with a different adjustment hole 20 and the pin 22 may be inserted into the pin hole 24 and adjustment hole 20 to fix the inner post 14 in a different position.

In certain embodiments, the pin 22 may include a first end, a second end, and a middle section. A handle 36 may be attached at the first end to easily grasp the pin 22. In certain embodiments, the pin 22 may include an upper flange 38 near the handle having an opening for the pin 22 to move freely within. The pin 22 may further include a lower flange 40 near the second end. A portion of the second end of the pin 22 may protrude passed the lower flange 40 to fit within the adjustment holes 20. A spring 42 may be disposed around the pin 22 and in between the upper flange 38 and the lower flange 40.

The pin 22 of the present invention may be attached to the outer post 12. In certain embodiments, the upper flange 38 may be permanently affixed to the outer post 12 or removably attachable to the outer post 12. For example, the upper flange 38 may include a threaded portion, and the pin hole 24 may include a threaded portion. Therefore, the upper flange 38 may screw into the pin hole 24 and secure the pin 22 to the outer post 12. Once the pin 22 has been secured to the outer post 12, a user may pull the handle away from the outer post 12 to remove the second end of the pin 22 from an adjustment hole 20. The inner post 14 may then be adjusted and the handle 36 may be released. Once the handle 26 is released the spring 42 may spring bias the pin 22 within an aligned adjustment hole 20.

In certain embodiments, more than one mailbox 34 may be attachable to the adjustable mailbox 10. The present invention may include a mailbox bracket 26 having a center portion forming an aperture sized to fit around the inner post 14. The mailbox bracket 26 may further include at least one arm extending from the center portion and having a mailbox plate 18. The mailbox bracket 26 may further include plurality of arms extending from the center portion, such as a first arm and a second arm. The center portion may be placed over and onto the inner post 14 and an additional mailbox may be attached to the mailbox plates 18. Therefore, the present invention may support more than one mailbox 34.

The mailbox bracket 26 may include a pin hole 24 through the center portion that is positioned to align with the adjustment holes 20 of the inner post 14. A second pin 22, similar to the pin 22 listed above, may run through the pin hole 24 and into one of the adjustment holes 20, fixing the mailbox bracket 26 in a fixed position. The mailbox bracket 26 may be adjusted along the height of the inner post 24 by removing the second pin 22 and moving the mailbox bracket 26 so that the pin hole 24 aligns with a different adjustment hole 20.

It should be understood, of course, that the foregoing relates to exemplary embodiments of the invention and that modifications may be made without departing from the spirit and scope of the invention as set forth in the following claims.

1. An apparatus comprising:
a post comprising a bottom end and a top end, a substantially hollow outer post comprising at least one pin hole and an inner post comprising a plurality of adjustment holes disposed along a height of the inner post, wherein the inner post fits within the outer post;
a pin sized to fit through a pin hole and an aligned adjustment hole of the plurality of adjustment holes to retain the inner post in a fixed position relative to the outer post; and
a mailbox attached to the top end of the post, wherein
the post comprises an adjustable height comprising at least a first height comprising the pin disposed through the pin hole and an aligned first adjustment hole, and a second height comprising the pin disposed through the pin hole and an aligned second adjustment hole.

2. The apparatus of claim 1, wherein the outer post comprises the bottom end and the inner post comprises the top end.

3. The apparatus of claim 2, further comprising a mailbox plate attached to the top end of the inner post, wherein the mailbox is attached to the mailbox plate.

4. (canceled)

5. (canceled)

6. The apparatus of claim 1, wherein the pin comprises a first end, a second end, and a middle section, wherein a handle is attached at the first end.

7. The apparatus of claim 6, wherein the pin further comprises an upper flange near the handle comprising an opening for the pin to move freely within, and a fixed lower flange near the second end of the pin, wherein a portion of the second end of the pin protrudes passed the lower flange, with a spring disposed in between the upper flange and the lower flange.

8. The apparatus of claim 7, wherein the pin hole of the outer post is threaded, and the upper flange is threaded and thereby releasably attachable to the outer post within the pin hole.

9. The apparatus of claim 1, further comprising a stop protruding within the substantially hollow outer post.

10. The apparatus of claim 1, further comprising a mailbox bracket comprising:
a center portion forming an aperture sized to fit around the inner post;
at least one arm extending laterally from the center portion; a mail box plate; and
a second mailbox secured to the mail box plate.

11. The apparatus of claim 10, wherein the center portion further comprises a pin hole positioned to align with the adjustment holes.

12. The apparatus of claim 11, further comprising a pin configured to fit through the pin hole and at least one of the adjustment holes to retain the mailbox bracket in a fixed position.

13. The apparatus of claim 12, wherein the pin comprises a first end, a second end, and a middle section, wherein a handle is attached at the first end.

14. The apparatus of claim 13, wherein the pin further comprises an upper flange near the handle comprising an opening for the pin to move freely within, and a fixed lower flange near the second end of the pin, wherein a portion of the bottom end of the pin protrudes passed the lower flange, with a spring disposed in between the upper flange and the lower flange.

15. The apparatus of claim 14, wherein the pin hole of the center portion is threaded, and the upper flange is threaded and thereby releasably attachable to the post within the pin hole.

16. The apparatus of claim 10, wherein the at least one arm is two arms extending from the center piece and each comprising a mail box plate.
